(19) United States
(12) Patent Application Publication
(10) Pub. No.: US 2019/0161607 A1
(43) Pub. Date: May 30, 2019

(54) CURABLE FLUOROELASTOMER COMPOSITION

(71) Applicant: SOLVAY SPECIALTY POLYMERS ITALY S.P.A., Bollate, MI (US)

(72) Inventors: Matteo FANTONI, Vanzaghello (IT); Liubov CHERNYSHEVA, Milano (IT); Marco AVATANEO, Milano (IT)

(21) Appl. No.: 16/309,451

(22) PCT Filed: Jun. 8, 2017
(86) PCT No.: PCT/EP2017/063972

§ 371 Date: Dec. 12, 2018

(30) Foreign Application Priority Data
Jun. 13, 2016 (EP) 16174246.5

(51) Int. Cl. C08L 27/16; C08K 5/14; C08K 5/3492; C08F 214/22; C08F 214/24; C08F 214/18

(52) U.S. Cl. CPC C08L 27/16; C08K 5/14; C08K 5/34924; C08K 5/34928; C08K 5/18; C08F 214/227; C08F 214/242; C08F 214/184; C08F 214/222

(57) ABSTRACT

The invention pertains to certain fluoroelastomer compositions comprising an iodine-containing (per)fluoroelastomer of low molecular weight and certain organic peroxides, possessing outstanding cross-linking behaviour at limited temperatures, and yielding resulting final parts exhibiting good mechanical and sealing properties, while avoiding discoloring/degradation phenomena, and enabling easy colour match in a wide range of colours.

### CROSS-REFERENCE TO RELATED APPLICATION

This application claims priority to European application No. 16174246.5 filed on Jun. 13, 2016, the whole content of this application being incorporated herein by reference for all purposes.

### TECHNICAL FIELD

The present invention relates to novel peroxide curable fluoroelastomer compositions, as well as a process for producing fluoroelastomer mouldings using the same.

### BACKGROUND ART

In the rubber industry there is a general desire for improved processability of the rubbers that are used, especially as regards the flow characteristics. The lower the viscosity of the rubber, the simpler the processing technology, the greater the productivity, and thus the less wastage there is. These aspects are very important, especially with fluororubbers, since these are expensive rubbers that cannot be processed completely on injection moulding machines used in the rubber industry.

So-called ‘liquid’ or low viscosity fluoroelastomers have been proposed in the art as materials intended for easier processing thanks to their reduced viscosity in the molten state. The challenge for processing liquid fluororubbers into shaped parts, is, while benefiting from easier flow of the material in the mould, of still ensuring outstanding curing capabilities, so as to provide for finished article having required mechanical and sealing properties starting from polymer chains of limited length.

In this area, U.S. Pat. No. 4,361,678 (DAIKIN IND LTD) 30 Nov. 1982 pertains to readily crosslinkable liquid fluorine-containing polymer having a certain amount of iodine in the molecule, having very low molecular weight (Mn of 900 to 10 000) and a narrow range of molecular weight distribution, whose crosslinking can be accomplished by various crosslinking procedures such as, inter alia, peroxide crosslinking to be effected in the presence of a polyfunctional olefin, wherein preferred organic peroxides are 1,1-bis(t-butylperoxy)-3,5,5-trimethylcyclohexane, 2,5-dimethylhexane-2,5-dihydroxyperoxide, di-t-butyl peroxide, t-butylcumyl peroxide, dicumyl peroxide, alpha,alpha′-bis(t-butyl-peroxy)-p-diisopropylbenzene, 2,5-dimethyl-2,5-di(t-butyl-peroxy)hexane, 2,5-dimethyl-2,5-di(t-butylperoxy)hexyne-3, benzoylperoxide, t-butylperoxybenzene, 2,5-dimethyl-2,5-di(benzoylperoxy)hexane, t-butylperoxymaleic acid, t-butylperoxiisopropyl carbonate, etc. Exemplary embodiment is crosslinked using diisopropyl peroxydicarbonate and triallylisocyanurate at 100° C. for 30 minutes, showing loss of solubility, without any indication of sealing and/or mechanical performances.

Further, document U.S. Pat. No. 5,852,125 (BAYER AG) 22 Dec. 1995 discloses VDF-based fluoroelastomers which can be pumped in liquid state at low temperatures (60-120° C.) and which are readily cross-linkable, said fluoroelastomers having a molecular weight of 3 000 to 30 000, comprising iodine and/or bromine as cure-site. The fluororubbers can be crosslinked, for example directly through the terminal iodine or bromine atoms as reactive groups, in a 100° C. to 250° C. hot mould. This crosslinking can be carried out in a conventional free radical way by radical-forming substances such as organic peroxides or by nucleophilic replacement of the terminal iodine, for example by means of polyfunctional amines.

Still, similar materials are also disclosed in document WO 98/15583 (BAYER AG [DE]) 16 Apr. 1998, which pertains to liquid fluoroelastomers having iodine content of 0.5 to 2.5% wt; having Mₙ between 10 000 and 25 000, with a polydispersity index (M_{w}/Mₙ) of strictly less than 1. The fluoroelastomer thereby provided are taught as cross-linkable radically by means of conventional commercial peroxides in combination with triallyl isocyanurate (TAIC), triallyl cyanurate, tri(meth)allyl isocyanurate, tetramethyltetravinylcyclotetra-siloxane, triallyl phosphite and/or N,N′-m-phenylenebismaleinimide, with 1,1-bis(tert.butylperoxy)-3,3,5-trimethylcyclohexane, biscumyl peroxide, bis(1,1-di-methylpropyl)peroxide, n-butyl-4,4-di(tert.butylperoxy)valerate, 2,5-dimethyl-2,5-di-(tert.butylperoxy)hexane, 1,3-bis(2-tert.butylperoxy-isopropyl)benzene, tert.butyl-cumylperoxide, bis(tert.amyl)peroxide, bis(tert.-butyl)peroxide and/or tert.butylper-benzoate as preferred peroxides. In all exemplified embodiments, the liquid rubbers are pressure-vulcanized at 170° C. under a pressure of 200 bars using a combination of TAIC and 2,5-dimethyl-2,5-bis(terbutylperoxy)-hexine-3, and post-cured according to a lengthy schedule, including 1 hour at 160° C., 1 hour at 170° C., 2 hours at 180° C. and 20 hours at 230° C.

Also, WO 2012/084587 (SOLVAY SPECIALTY POLYMERS IT) 28 Jun. 2012 pertains to certain low viscosity curable (per)fluoroelastomers having a number-averaged molecular weight of 3 000 to 45 000, and discloses peroxide curable compositions comprising the same in combination with an organic peroxide, which can be notably di-tert-butyl peroxide and 2,5-dimethyl-2,5-bis(tert-butylperoxy)hexane; dicumyl peroxide; dibenzoyl peroxide; di-tert-butyl perbenzoate; bis[1,3-dimethyl-3-(tert-butylperoxy)butyl] carbonate. In all exemplified embodiment, use is made of 2,5-dimethyl-2,5-di-t-butyl-peroxy-hexane; curing is carried out at 170° C. and post-curing at 180° C. for 4 hours.

Further, WO 2014/071129 (3M INNOVATIVE PROPERTIES CO) 8 May 2014 pertains to certain curable compositions that includes an amorphous, peroxide-curable, a solvent, and a peroxide. An exemplary composition includes a fluoroelastomer “A” having a Mooney viscosity (100° C.) of 2.1 and 2 phr of benzoyl peroxide. Values of Mooney viscosity at 100° C. of 0.8 to 1.6 are known to correspond to fluoroelastomers having number-averaged molecular weight of exceeding 30 000 (see for instance WO 2009/36131 (3M INNOVATIVE PROPERTIES) 19 Mar. 2009, Table 2). Hence, the fluoroelastomer “A” referred above is a fluoroelastomer possessing a number averaged molecular weight largely exceeding 30 000.

As a whole, hence, experiences with fluoroelastomers as above detailed have shown that when selecting fluoroelastomers having limited molecular weight (e.g. a weight averaged molecular weight of about 10÷30 k), the mold-curing and post-cure is generally understood to require high temperatures, so as to achieve a plateau in sealing and mechanical properties. Those harsh conditions may be detrimental to aesthetic appearance of the molded/cured specimens, due to degradation phenomena which may be more significant for lower molecular weight polymers. Absence of yellowing is notably of peculiar interest when fluoroelastomers are cured into parts which have to match specific colour requirements, in particular for bright colours. This aspect is of particular interest when the fluoroelastomers are intended for use in the manufacture of jewelry items, such as bracelets, wrist bands for watch, packing for outer cladding components of clocks and watches, and the like, wherein the aesthetic appearance, on top of mechanical properties, are of peculiar interest.

Furthermore, avoiding harsh curing/post-curing conditions further enlarges the range of possible colorants which may be used, as the choice of pigments and dye suitable for colouring fluoroelastomers has been historically limited because of high temperature resistance requirements for said pigments and dye to withstand processing conditions.

There is thus still a current shortfall in the art for peroxide curable fluoroelastomer compositions that possess outstanding cross-linking behaviour at limited temperatures, and yielding resulting final parts exhibiting good mechanical and sealing properties, while avoiding discoloring/degradation phenomena, and enabling easy colour match in a wide range of colours.

The object of the present invention is therefore to provide fluoroelastomer compositions that advantageously exhibit this property profile.

### SUMMARY OF INVENTION

It is thus an object of the present invention a fluoroelastomer composition comprising:
a (per)fluoroelastomer [fluoroelastomer (A)] having a number-averaged molecular weight of 10 000 to 30 000, said (per)fluoroelastomer comprising iodine atoms in an amount of 0.5 to 10.0% wt with respect to the total weight of fluoroelastomer (A);
at least one organic peroxide [peroxide (O)] selected from the group consisting of di(3-carboxypropionyl) peroxide, 2,5-dimethyl-2,5-di(2-ethylhexanoylperoxy)hexane, dibenzoyl peroxide, t-amylperoxy 2-ethylhexanoate, t-butylperoxy 2-ethylhexanoate, t-butyl peroxyisobutyrate, t-butyl peroxy-(cis-3-carboxy)propenoate, 1,1-di(t-amylperoxy)cyclohexane, said peroxide (O) being comprised in an amount of at least 1.8 phr and at most 5.0 phr.

The Applicant has surprisingly found that by careful selection of the iodine content in the fluoroelastomer (A), of the nature of the organic peroxide, as well as the amount of the said organic peroxide, it is possible to efficiently cause the curable composition therefrom to cure in mild conditions (i.e. with mold-curing at temperatures of at most 120° C. and post-curing at temperatures of not more than 170° C. for achieving full mechanical properties' potential) and provide final cured parts possessing suitable mechanical and sealing properties and very advantageous colour properties, so as to enable colour matching in a wide range of colours.

For the purposes of this invention, the term “(per)fluoroelastomer” [fluoroelastomer (A)] is intended to designate a fluoropolymer resin serving as a base constituent for obtaining a true elastomer, said fluoropolymer resin comprising more than 10% wt, preferably more than 30% wt, of recurring units derived from at least one ethylenically unsaturated monomer comprising at least one fluorine atom (hereafter, (per)fluorinated monomer) and, optionally, recurring units derived from at least one ethylenically unsaturated monomer free from fluorine atom (hereafter, hydrogenated monomer).

True elastomers are defined by the ASTM, Special Technical Bulletin, No. 184 standard as materials capable of being stretched, at room temperature, to twice their intrinsic length and which, once they have been released after holding them under tension for 5 minutes, return to within 10% of their initial length in the same time.

Non limitative examples of suitable (per)fluorinated monomers are notably:
C₂-C₈ fluoro- and/or perfluoroolefins, such as tetrafluoroethylene (TFE), hexafluoropropene (HFP), pentafluoropropylene, and hexafluoroisobutylene, vinyl fluoride; 1,2-difluoroethylene, vinylidene fluoride (VDF) and trifluoroethylene (TrFE);
(per)fluoroalkylethylenes complying with formula CH₂═CH—R_{f0}, in which R_{f0} is a C₁-C₆ (per)fluoroalkyl or a C₁-C₆ (per)fluorooxyalkyl having one or more ether groups;
chloro- and/or bromo- and/or iodo-C₂-C₆ fluoroolefins, like chlorotrifluoroethylene (CTFE);
fluoroalkylvinylethers complying with formula CF₂═CFOR_{f1} in which R_{f1} is a C₁-C₆ fluoro- or perfluoroalkyl, e.g. —CF₃, —C₂F₅, —C₃F₇;
hydrofluoroalkylvinylethers complying with formula CH₂═CFOR_{f1} in which R_{f1} is a C₁-C₆ fluoro- or perfluoroalkyl, e.g. —CF₃, —C₂F₅, —C₃F₇;
fluoro-oxyalkylvinylethers complying with formula CF₂═CFOX₀, in which X₀ is a C₁-C₁₂ oxyalkyl, or a C₁-C₁₂ (per)fluorooxyalkyl having one or more ether groups; in particular (per)fluoro-methoxy-vinylethers complying with formula CF₂═CFOCF₂OR_{f2} in which R_{f2} is a C₁-C₆ fluoro- or perfluoroalkyl, e.g. —CF₃, —C₂F₅, —C₃F₇ or a C₁-C₆ (per)fluorooxyalkyl having one or more ether groups, like —C₂F₅—O—CF₃;
functional fluoro-alkylvinylethers complying with formula CF₂═CFOY₀, in which Y₀ is a C₁-C₁₂ alkyl or (per)fluoroalkyl, or a C₁-C₁₂ oxyalkyl or a C₁-C₁₂ (per)fluorooxyalkyl, said Y₀ group comprising a carboxylic or sulfonic acid group, in its acid, acid halide or salt form;
(per)fluorodioxoles, of formula:

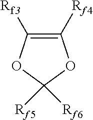

wherein each of R_{f3}, R_{f4}, R_{f5}, R_{f6}, equal to or different from each other, is independently a fluorine atom, a C₁-C₆ fluoro- or per(halo)fluoroalkyl, optionally comprising one or more oxygen atom, e.g. —CF₃, —C₂F₅, —C₃F₇, —OCF₃, —OCF₂CF₂OCF₃.

Examples of hydrogenated monomers are notably hydrogenated alpha-olefins, including ethylene, propylene, 1-butene, diene monomers, styrene monomers, alpha-olefins being typically used.

Fluoroelastomers (A) are in general amorphous products or products having a low degree of crystallinity (crystalline phase less than 20% by volume) and a glass transition temperature (T_{g}) below room temperature. In most cases, the fluoroelastomer (A) has advantageously a T_{g} below 10° C., preferably below 5° C., more preferably 0° C.

The fluoroelastomer (A) is preferably selected among:

(1) VDF-based copolymers, in which VDF is copolymerized with at least one comonomer selected from the group consisting of:

(a) C₂-C₈ perfluoroolefins, such as tetrafluoroethylene (TFE), hexafluoropropylene (HFP);

(b) hydrogen-containing C₂-C₈ olefins, such as vinyl fluoride (VF), trifluoroethylene (TrFE), hexafluoroisobutene (HFIB), perfluoroalkyl ethylenes of formula CH₂═CH—R_{f}, wherein R_{f} is a C₁-C₆ perfluoroalkyl group;

(c) C₂-C₈ fluoroolefins comprising at least one of iodine, chlorine and bromine, such as chlorotrifluoroethylene (CTFE);

(d) (per)fluoroalkylvinylethers (PAVE) of formula CF₂═CFOR_{f}, wherein R_{f} is a C₁-C₆ (per)fluoroalkyl group, preferably CF₃, C₂F₅, C₃F₇;

(e) (per)fluoro-oxy-alkylvinylethers of formula CF₂═CFOX, wherein X is a C₁-C₁₂ ((per)fluoro)-oxyalkyl comprising catenary oxygen atoms, e.g. the perfluoro-2-propoxypropyl group;

(f) (per)fluorodioxoles having formula:

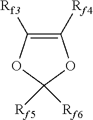

wherein each of R_{f3}, R_{f4}, R_{f5}, R_{f6}, equal to or different from each other, is independently selected from the group consisting of fluorine atom and C₁-C₆ (per)fluoroalkyl groups, optionally comprising one or more than one oxygen atom, such as notably —CF₃, —C₂F₅, —C₃F₇, —OCF₃, —OCF₂CF₂OCF₃; preferably, perfluorodioxoles;

(g) (per)fluoro-methoxy-vinylethers (MOVE, hereinafter) having formula:

CF₂═CFOCF₂OR_{f2}

wherein R_{f2} is selected from the group consisting of C₁-C₆ (per)fluoroalkyls; C₅-C₆ cyclic (per)fluoroalkyls; and C₂-C₆ (per)fluorooxyalkyls, comprising at least one catenary oxygen atom; R_{f2} is —CF₂CF₃ (MOVE1); —CF₂CF₂OCF₃ (MOVE2); or —CF₃ (MOVE3);

(h) C₂-C₈ non-fluorinated olefins (Ol), for example ethylene and propylene;

(i) ethylenically unsaturated compounds comprising nitrile (—CN) groups, possibly (per)fluorinated; and

(2) TFE-based copolymers, in which TFE is copolymerized with at least one comonomer selected from the group consisting of (c), (d), (e), (g), (h) and (i) as above detailed.

Optionally, fluoroelastomer (A) of the present invention also comprises recurring units derived from a bis-olefin [bis-olefin (OF)] having general formula:

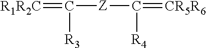

wherein R₁, R₂, R₃, R₄, R₅ and R₆, equal or different from each other, are H or C₁-C₅ alkyl; Z is a linear or branched C₁-C₁₈ hydrocarbon radical (including alkylene or cycloalkylene radical), optionally containing oxygen atoms, preferably at least partially fluorinated, or a (per)fluoropolyoxyalkylene radical, e.g. as described in EP 661304 A (AUSIMONT SPA) 5 Jul. 1995.

The bis-olefin (OF) is preferably selected from the group consisting of those complying with formulae (OF-1), (OF-2) and (OF-3):

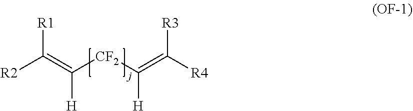

wherein j is an integer between 2 and 10, preferably between 4 and 8, and R1, R2, R3, R4, equal or different from each other, are H, F or C₁₋₅ alkyl or (per)fluoroalkyl group;

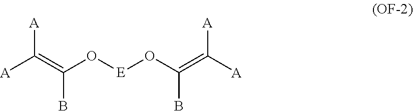

wherein each of A, equal or different from each other and at each occurrence, is independently selected from F, Cl, and H; each of B, equal or different from each other and at each occurrence, is independently selected from F, Cl, H and OR_{B}, wherein R_{B} is a branched or straight chain alkyl radical which can be partially, substantially or completely fluorinated or chlorinated; E is a divalent group having 2 to 10 carbon atom, optionally fluorinated, which may be inserted with ether linkages; preferably E is a (CF₂)ₘ— group, with m being an integer from 3 to 5; a preferred bis-olefin of (OF-2) type is F₂C═CF—O—(CF₂)₅—O—CF═CF₂.

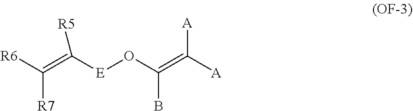

wherein E, A and B have the same meaning as above defined; R5, R6, R7, equal or different from each other, are H, F or C₁₋₅ alkyl or (per)fluoroalkyl group.

Exemplary fluoroelastomers (A) which can be used in the composition of the present invention are those having following monomers composition (in mol %, with respect to the total moles of recurring units):

(i) vinylidene fluoride (VDF) 35-85%, hexafluoropropene (HFP) 10-45%, tetrafluoroethylene (TFE) 0-30%, (per)fluoroalkylvinylethers (PAVE) 0-15%; bis-olefin (OF): 0-5%;

(ii) vinylidene fluoride (VDF) 50-80%, (per)fluoroalkylvinylethers (PAVE) 5-50%, tetrafluoroethylene (TFE) 0-20%, bis-olefin (OF): 0-5%;

(iii) vinylidene fluoride (VDF) 20-30%, C₂-C₈ non-fluorinated olefins (Ol) 10-30%, hexafluoropropene (HFP) and/or (per)fluoroalkylvinylethers (PAVE) 18-27%, tetrafluoroethylene (TFE) 10-30%; bis-olefin (OF): 0-5%;

(iv) tetrafluoroethylene (TFE) 50-80%, (per)fluoroalkylvinylethers (PAVE) 15-50%; bis-olefin (OF): 0-5%;

(v) tetrafluoroethylene (TFE) 45-65%, C₂-C₈ non-fluorinated olefins (Ol) 20-55%, vinylidene fluoride 0-30%; bis-olefin (OF): 0-5%;

(vi) tetrafluoroethylene (TFE) 32-60% mol %, C₂-C₈ non-fluorinated olefins (Ol) 10-40%, (per)fluoroalkylvinylethers (PAVE) 20-40%, fluorovinyl ethers (MOVE) 0-30%; bis-olefin (OF): 0-5%;

(vii) tetrafluoroethylene (TFE) 33-75%, (per)fluoroalkylvinylethers (PAVE) 15-45%, vinylidene fluoride (VDF) 5-30%, hexafluoropropene HFP 0-30%; bis-olefin (OF): 0-5%;

(viii) vinylidene fluoride (VDF) 35-85%, (per)fluoro-methoxy-vinylethers (MOVE) 5-40%, (per)fluoroalkylvinylethers (PAVE) 0-30%, tetrafluoroethylene (TFE) 0-40%, hexafluoropropene (HFP) 0-30%; bis-olefin (OF): 0-5%;

(ix) tetrafluoroethylene (TFE) 20-70%, (per)fluoro-methoxy-vinylethers (MOVE) 25-75%, (per)fluoroalkylvinylethers (PAVE) 0-50%, bis-olefin (OF): 0-5%.

The fluoroelastomer of the invention has a number-averaged molecular weight of 15 000 to 45 000.

The mathematical expression of number average molecular weight (Mₑ) is:

$${M}_{n} = \frac{Σ {M}_{i} \cdot {N}_{i}}{Σ {N}_{i}} ,$$

wherein Mᵢ is the molecular weight of the macromolecule(s) of length i and Nᵢ is their number, which can be notably determined by GPC.

Other molecular parameters which can be notably determined by GPC are the weight average molecular weight (M_{w}):

$${M}_{w} = \frac{Σ {M}_{i}^{2} \cdot {N}_{i}}{Σ {M}_{i} \cdot {N}_{i}} ,$$

wherein Mᵢ is the molecular weight of the macromolecule(s) of length i and Nᵢ is their number; and

the polydispersity index (PDI), which is hereby expressed as the ratio of weight average molecular weight (M_{w}) to number average molecular weight (Mₙ).

The number average molecular weight (Mₙ), the weight average molecular weight (M_{w}) and the polydispersity index (PDI) can be determined by GPC using as solvent THF and against a calibration curve based on polystyrene monodisperse standards having molecular weight from 1700 to 4 000 000.

The fluoroelastomer (A) of the invention has a number-averaged molecular weight of preferably at least 11 000, more preferably at least 11 500, even more preferably at least 12 000.

The fluoroelastomer (A) of the invention has a number-averaged molecular weight of at most 30 000, more preferably at most 25 000, even more preferably at most 20 000.

The fluoroelastomer (A) can comprise iodine atoms either as pendant groups bonded to certain recurring units or as end groups of the polymer chain.

Iodine atoms can be notably be incorporated in the fluoroelastomer (A) through recurring units derived from iodinated cure-site monomers selected from the group consisting of:

(CSM-A) iodine-containing perfluorovinylethers of formula:

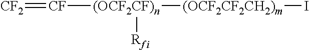

with m being an integer from 0 to 5 and n being an integer from 0 to 3, with the provisio that at least one of m and n is different from 0, and R_{fi} being F or CF₃; (as notably described in U.S. Pat. No. 4,745,165 (AUSIMONT SPA) 17 May 1988, U.S. Pat. No. 4,564,662 (MINNESOTA MINING & MFG [US]) 14 Jan. 1986 and EP 199138 A (DAIKIN IND LTD) 29 Oct. 1986); and (CSM-B) iodine-containing ethylenically unsaturated compounds of formula:

CX¹X²═CX³—(CF₂CF₂)—I

wherein each of X¹, X² and X³, equal to or different from each other, are independently H or F; and p is an integer from 1 to 5; among these compounds, mention can be made of CH₂═CHCF₂CF₂I, I(CF₂CF₂)₂CH═CH₂, ICF₂CF₂CF═CH₂, I(CF₂CF₂)₂CF═CH₂;

(CSM-C) iodine-containing ethylenically unsaturated compounds of formula:

CHR═CH—Z—CH₂CHR—I

wherein R is H or CH₃, Z is a C₁-C₁₈ (per)fluoroalkylene radical, linear or branched, optionally containing one or more ether oxygen atoms, or a (per)fluoropolyoxyalkylene radical; among these compounds, mention can be made of CH₂═CH—(CF₂)₄CH₂CH₂I, CH₂═CH—(CF₂)₆CH₂CH₂I, CH₂═CH—(CF₂)₈CH₂CH₂I, CH₂═CH—(CF₂)₂CH₂CH₂I;

(CSM-D) iodo-containing alpha-olefins containing from 2 to 10 carbon atoms such as described, for example, in U.S. Pat. No. 4,035,565 (DU PONT) 12 Jul. 1977 or in U.S. Pat. No. 4,694,045 (DU PONT) 15 Sep. 1987.

The fluoroelastomer according to this embodiment generally comprises recurring units derived from iodinated cure-site monomers in amounts of 0.05 to 5 mol per 100 mol of all other recurring units of the fluoroelastomer, so as to advantageously ensure above mentioned iodine weight content.

According to a second preferred embodiment, the iodine atoms are comprised as end groups of the fluoroelastomer polymer chain; the fluoroelastomer according to this embodiment is generally obtained by addition to the polymerization medium during fluoroelastomer manufacture of anyone of:
iodinated and/or brominated chain-transfer agent(s); suitable chain-chain transfer agents are typically those of formula R_{f}(I)ₓ(Br)_{y}, in which R_{f} is a (per)fluoroalkyl or a (per)fluorochloroalkyl containing from 1 to 8 carbon atoms, while x and y are integers between 0 and 2, with 1≤x+y≤2 (see, for example, U.S. Pat. No. 4,243,770 (DAIKIN IND LTD) 6 Jan. 1981 and U.S. Pat. No. 4,943,622 (NIPPON MEKTRON KK) 24 Jul. 1990); and
alkali metal or alkaline-earth metal iodides and/or bromides, such as described notably in U.S. Pat. No. 5,173,553 (AUSIMONT SRL) 22 Dec. 1992.

The fluoroelastomer (A) comprises advantageously iodine atoms in an amount of at least 0.8, preferably at least 1.0, more preferably at least 1.5% wt, with respect to the total weight of fluoroelastomer (A) and/or in an amount of at most 7.0, preferably at most 5.0, more preferably at most 3.0% wt, with respect to the total weight of fluoroelastomer (A).

As said, the composition of the invention comprises at least one peroxide (O), which are selected in view of their ability to generate radicals at relatively low temperature with appreciable kinetics, and their ability to provide non-coloured decomposition residues, which will not impact the final colour of the fluoroelastomer molded part.

Among peroxides (O), as above detailed, dibenzoyl peroxide is particularly preferred.

As said, the amount of peroxide to be used is to be finely tuned for achieving satisfactory curing behaviour with low molecular weight fluoroelastomers.

As said, an amount of peroxide (O) of at least 1.8 phr will be required, with respect to the fluoroelastomer (A) weight.

Upper boundaries will be generally adjusted so as to use the peroxide (O) in an amount of preferably less than 4.5 phr, more preferably less than 4 phr, with respect to the fluoroelastomer (A) weight.

The composition of the invention may additionally comprise one or more than one of the following optional ingredients:

(a) at least one curing coagent, in amount generally of between 0.5 to 10 phr and preferably between 1 and 7 phr relative to the fluoroelastomer (A); among these agents, the following are commonly used: triallyl cyanurate; triallyl isocyanurate (TAIC); tris(diallylamine)-s-triazine; triallyl phosphite; N,N-diallylacrylamide; N,N,N′,N′-tetraallylmalonamide; trivinyl isocyanurate; 2,4,6-trivinyl methyltrisiloxane; bis-olefins (OF), as above detailed; triazines substituted with ethylenically unsaturated groups, such as notably those described in EP 860436 A (AUSIMONT SPA) 26 Aug. 1998 and WO 97/05122 (DU PONT [US]) 13 Feb. 1997; among above mentioned curing coagents, TAIC and bis-olefins (OF), as above detailed, and more specifically those of formula (OF-1), as above detailed, have been found to provide particularly good results;

(b) at least one metallic compound, in amount of generally between 1 and 15 phr, and preferably between 2 and 10 phr relative to the fluoroelastomer (A), selected from the group consisting of oxides and hydroxides of divalent metals, for instance Mg, Zn, Ca or Pb, optionally combined with a salt of a weak acid, for instance Ba, Na, K, Pb, Ca stearates, benzoates, carbonates, oxalates or phosphites;

(c) at least one acid acceptor different from metal oxides, such as 1,8-bis(dimethylamino)naphthalene, octadecylamine, etc., as notably described in EP 708797 A (DU PONT) 1 May 1996;

(d) at least one of other conventional additives, such as fillers, thickeners, antioxidants, stabilizers, processing aids, and the like.

According to certain preferred embodiments, the composition of the invention comprises at least one colorant selected from pigments and dyes, in an amount of 0.1 to 10 phr.

Pigments are insoluble materials which are admixed with the fluoroleastomer (A); pigments may be organic or inorganic.

Dyes are soluble additives, which are dissolved in the fluoroelastomer (A) matrix.

Among white colorants, white pigments are preferably used. The choice of white pigments is not particularly limited, but generally use is made of TiO2, ZnO, ZnS or BaSO₄ pigments, more preferably of TiO₂ pigment (in particular rutile form).

Colored inorganic pigments which can be used include notably chromium pigments like chrome yellow and chrome green; iron oxide pigment, including oxide red, Prussian blue; cobalt pigments, such as cobalt violet, cobalt blue; ultramarine pigments (sulfur-containing sodium-silicate of general formula: Na₈₋₁₀Al₆Si₆O₂₄S₂₋₄), including ultramarine blue, ultramarine violet and ultramarine pink.

Colored organic pigments which can be used include notably anthoxanthins; azo-compounds; carmine; indigo, phthalocyanines; naphthol reds; diarylide yellow pigments (including e.g. pigment yellow 13; 34; 83; 81; 17; 14; 16); monoazopyrazolone pigments including benzidine yellow 10G.

The invention also pertains to the use of the composition including the fluoroelastomer (A) as above described for fabricating shaped articles.

The composition of the invention can be fabricated, e.g. by moulding (injection moulding, extrusion moulding), calendering, or extrusion, into the desired shaped article, which is advantageously subjected to vulcanization (curing) during the processing itself and/or in a subsequent step (post-treatment or post-cure), advantageously transforming the relatively soft, weak, fluoroelastomer into a finished article made of non-tacky, strong, insoluble, chemically and thermally resistant cured fluoroelastomer.

More specifically, the invention further pertains to a method of fabricating a shaped article including moulding and curing the composition as above detailed. The method advantageously comprises a step of simultaneously moulding and curing the composition as above detailed at a temperature of at most 130° C., followed by de-moulding so as to obtain a pre-formed article; and a step of post-curing the so obtained pre-formed article in an oven at a temperature of at most 170° C.

The method can be notably used for fabricating shaped articles selected from the group consisting of jewelry items, including notably bracelets, wrist bands for watches, packing for outer cladding components of clocks and watches.

Finally, the invention pertains to cured articles obtained from the fluoroelastomer (A). Said cured articles are generally obtained by moulding and curing the peroxide curable composition, as above detailed.

Further in addition, the invention pertains to a method for processing fluoroelastomer (A) according any of liquid injection moulding technique, screen printing technique, form-in-place technique. These techniques are described above.

Should the disclosure of any of the patents, patent applications, and publications that are incorporated herein by reference conflict with the present description to the extent that it might render a term unclear, the present description shall take precedence.

The present invention will be now described in more detail with reference to the following examples, whose purpose is merely illustrative and not limitative of the scope of the invention.

### EXAMPLES

### Preparative Example 1—Manufacture of a Fluoroelastomer of Low Mn

In a 10 liters reactor equipped with a mechanical stirrer operating at 545 rpm, 5.4 l of demineralized water and 40 ml of a microemulsion, previously obtained by mixing 8.8 ml of a perfluoropolyoxyalkylene having acidic end groups of formula: CF₂ClO(CF₂—CF(CF₃)O)ₙ(CF₂O)ₘCF₂COOH, wherein n/m=10, having average molecular weight of 600, 5.6 ml of a 30% v/v NH₄OH aqueous solution, 20.0 ml of demineralized water and 5.5 ml of GALDEN® D02 perfluoropolyether of formula: CF₃O(CF₂CF(CF₃)O)ₙ(CF₂O)ₘCF₃ with n/m=20, having average molecular weight of 450, were introduced. The reactor was heated and maintained at a set-point temperature of 80° C. A mixture of tetrafluoroethylene (TFE) (11% moles), vinylidene fluoride (VDF) (70% moles) and hexafluoropropylene (HFP) (19% moles) was then added to reach a final pressure of 30 bar (3.0 MPa). 54 ml of 1,4-diiodoperfluorobutane (C₄F₈I₂) as chain transfer agent and 1.8 g of ammonium persulfate (APS) as initiator were then introduced. Pressure was maintained at set-point of 30 bar by continuous feeding of a gaseous mixture of TFE (11% moles), VDF (70% moles) and HFP (19% moles) up to a total of 3150 g. Then the reactor was cooled, vented and the latex recovered. The latex was coagulated by freezing and subsequent thawing, the polymer separated from the aqueous phase, washed with demineralised water and dried in a convection oven at 100° C. for 16 hours.

A fluoroelastomer was so recovered having the following molar composition: TFE: 11% moles; VDF: 70% moles; HFP: 19% moles, comprising 2.3% wt of iodine. This fluoroelastomer, when analyzed by GPC, by dissolving a sample thereof at about 0.5% wt/vol concentration in tetrahydrofurane for 6 hours under magnetic stirring at room temperature; the solution so obtained was filtered over a PTFE filter having 0.45 μm pore size and the filtered solution was injected in the GPC system; details of the GPC conditions are listed hereinafter:

Mobile phase Tetrahydrofuran; Flow rate 1.0 mL/min; Temperature 35° C.; Injection system Autosampler model 717 plus; Injection volume 200 μl; Pump Isocratic Pump model 515; Column set Precolumn+4 Waters Styragel HR: 10⁶, 10⁵, 10⁴ and 10³ Å; DetectorWaters Refractive Index model 2414; Software for data acquisition and processing: Waters Empower 3. The fluoroelastomer was found to possess a Mₙ of 12 398, a M_{w} of 23 355, and a polydispersity index of 1.9; substantially no fraction was found having a molecular weight of below 1 000.

The Mooney Viscosity measured at 200° C. (1+10 min) according to ASTM D1646 provided non-measurable values, more precisely values below the detection limit of the instrument, demonstrating the very low viscosity as related to the molecular weight.

Fluoroelastomer of Preparative Example 1 was compounded with the additives, as specified in Table below, in a Speedmixer. Plaques were cured in a pressed mould and then post-treated in an air circulating oven in conditions (time, temperature) below specified.

Cure behaviour was characterized by Moving Die Rheometer (MDR), in the conditions specified in the Table below, by determining the following properties:

M_{L}=Minimum torque (lb×in)

M_{H}=Maximum torque (lb×in)

t_{S2}=Scorch time, time for two units rise from M_{L} (sec);

t₀₂=Time to 2% state of cure (sec);

t₅₀=Time to 50% state of cure (sec);

t₉₀=Time to 90% state of cure (sec).

The tensile properties have been determined on specimens punched out from the plaques, according to the DIN 53504 S2 Standard, wherein:

M50 is the tensile strength in MPa at an elongation of 100%;

M100 is the tensile strength in MPa at an elongation of 100%;

TS is the tensile strength in MPa;

EB is the elongation at break in %.

The Shore A hardness (3″) (HDS) has been determined on 3 pieces of plaque piled according to the ASTM D 2240 method. Compression set values have been determined on 3 disks punched out from the plaques piled according to the ASTM D 395-B method.

Yellow Index has been determined according to the ASTM E313 method.

Curing recipe and conditions and properties of cured sample are summarized in Table 1.

TABLE 2

| Recipe title | | Ex. 2C | Ex. 3 | Ex. 4 |
|---|---|---|---|---|
| Polymer from Ex.1 | (wt parts) | 100.00 | 100.00 | 100.00 |
| Taicros ®-Degussa^{(\hat{ })} | (phr) | 2.50 | 2.50 | 2.50 |
| Luperox ® A70S- | (phr) | | 1.80 | 3.60 |
| Sigma Aldrich (*) | | | | |
| Trigonox ® 101-Akzo | (phr) | 1.50 | | |
| Nobel^{(#)} | | | | |
| MDR @ 120° C. | | 36 min @ | 12 min @ | 12 min @ |
| | | 120° C. | 120° C. | 120° C. |
| M_{L} | lb*in | | 0.0 | 0.0 |
| M_{H} | lb*in | | 7.1 | 6.9 |
| t_{S2} | S | do not cure | 97 | 69 |
| t₀₂ | S | | 62 | 47 |
| t₅₀ | S | | 152 | 95 |
| t₉₀ | S | | 590 | 338 |

MDR 12 min @ 170° C.

| | | |
|---|---|---|
| M_{L} | lb*in | 0.0 |
| M_{H} | lb*in | 6.2 |
| t_{S2} | S | 66 |
| t₀₂ | S | 41 |
| t₅₀ | S | 111 |
| t₉₀ | S | 581 |

| | | | |
|---|---|---|---|
| Molding-duration = t₉₀ | t₉₀ @ | t₉₀ @ | t₉₀ @ |
| | 170° C. | 120° C. | 120° C. |

No Postcure
Mechanical Properties 23° C. DIN 53504 S2

| | | | | |
|---|---|---|---|---|
| TS | MPa | 2.1 | 2.8 | 1.8 |
| M50 | MPa | 0.9 | 1.0 | 1.0 |
| M1000 | MPa | 1.1 | 1.3 | 1.3 |
| EB | % | 156 | 137 | 109 |
| Hardness | Shore A | 50 | 53 | 54 |

Post-cure 4 h @ 150° C.
Mechanical Properties, 23° C. DIN 53504 S2

| | | | | |
|---|---|---|---|---|
| Tensile Strength | MPa | 2.8 | 2.5 | 2.6 |
| 50% Modulus | MPa | 0.8 | 1.0 | 1.0 |
| 100% Modulus | MPa | 1.1 | 1.3 | 1.4 |
| Elongation @ Break | % | 198 | 143 | 133 |
| Hardness | Shore A | 52 | 54 | 55 |

Post-cure 4 h @ 190° C.
Mechanical Properties, 23° C. DIN 53504 S2

| | | | | |
|---|---|---|---|---|
| Tensile Strength | MPa | 2.9 | 2.5 | 2.7 |
| 50% Modulus | MPa | 0.8 | 1.0 | 1.0 |
| 100% Modulus | MPa | 1.1 | 1.3 | 1.4 |
| Elongation @ Break | % | 201 | 150 | 134 |
| Hardness | Shore A | 51 | 54 | 55 |

Post-cure 4 h @ 230° C.
Mechanical Properties, 23° C. DIN 53504 S2

| | | | | |
|---|---|---|---|---|
| Tensile Strength | MPa | 3.1 | 3.2 | 2.9 |
| 50% Modulus | MPa | 0.9 | 1.0 | 1.0 |
| 100% Modulus | MPa | 1.1 | 1.3 | 1.3 |
| Elongation @ Break | % | 201 | 163 | 145 |
| Hardness | Shore A | 51 | 53 | 55 |
| Yellow index E313 | | | | |
| No postcure | YI | 34.6 | 13.8 | 20.6 |
| Postcure 4 h @ 150° C. | YI | 62.2 | 30.7 | 49.9 |
| Postcure 4 h @ 170° C. | YI | 91.7 | 45.8 | 65.9 |
| Postcure 4 h @ 190° C. | YI | 98.6 | 55.5 | 76.8 |
| Postcure 4 h @ 230° C. | YI | 112.6 | 123.0 | 137.2 |

^{(\hat{ })}Taicros ® is neat triallylisocyanurate;
^{(*)}Luperox ® A705 is a mixture of benzoyl peroxide (70%) and water; the amount listed above in phr wrt fluoroelastomer are referred to neat benzoyl peroxide;
^{(#)}Trigonox ® is neat 2,5-dimethyl-2,5-di(ter-butylperoxy)hexane.

1. A fluoroelastomer composition comprising:
a (per)fluoroelastomer [fluoroelastomer (A)] having a number-averaged molecular weight of 10 000 to 30 000, said (per)fluoroelastomer comprising iodine atoms in an amount of 0.5 to 10.0% wt with respect to the total weight of fluoroelastomer (A);
at least one organic peroxide (O) selected from the group consisting of di(3-carboxypropionyl) peroxide, 2,5-dimethyl-2,5-di(2-ethylhexanoylperoxy) hexane, dibenzoyl peroxide, t-amylperoxy 2-ethylhexanoate, t-butylperoxy 2-ethylhexanoate, t-butyl peroxyisobutyrate, t-butyl peroxy-(cis-3-carboxy)propenoate, and 1,1-di(t-amylperoxy)cyclohexane, said peroxide (O) being present in the fluoroelastomer composition in an amount of at least 1.8 phr and at most 5.0 phr.

2. The fluoroelastomer composition of claim 1, wherein the peroxide (O) is dibenzoyl peroxide.

3. The fluoroelastomer composition of claim 1, wherein fluoroelastomer (A) is selected from the group consisting of:
(1) VDF-based copolymers, wherein VDF is copolymerized with at least one comonomer selected from the group consisting of:
(a) C₂-C₈ perfluoroolefins;
(b) hydrogen-containing C₂-C₈ olefins;
(c) C₂-C₈ fluoroolefins comprising at least one of iodine, chlorine and bromine;
(d) (per)fluoroalkylvinylethers (PAVE) of formula CF₂═CFOR_{f}, wherein R_{f} is a C₁-C₆ (per)fluoroalkyl group;
(e) (per)fluoro-oxy-alkylvinylethers of formula CF₂═CFOX, wherein X is a C₁-C₁₂ ((per)fluoro)-oxyalkyl comprising catenary oxygen atoms;
(f) (per)fluorodioxoles having formula: 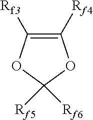
wherein each of R_{f3}, R_{f4}, R_{f5}, R_{f6}, equal to or different from each other, is independently selected from the group consisting of fluorine atom and C₁-C₆ (per)fluoroalkyl groups, optionally comprising one or more than one oxygen atom;
(g) (per)fluoro-methoxy-vinylethers having formula:
CF₂═CFOCF₂OR_{f2}
wherein R_{f2} is selected from the group consisting of C₁-C₆ (per)fluoroalkyls; C₅-C₆ cyclic (per)fluoroalkyls; and C₂-C₆ (per)fluorooxyalkyls, comprising at least one catenary oxygen atom;
(h) C₂-C₈ non-fluorinated olefins (Ol); and
(i) ethylenically unsaturated compounds comprising nitrile (—CN) groups, optionally (per)fluorinated; and
(2) TFE-based copolymers, wherein TFE is copolymerized with at least one comonomer selected from the group consisting of (c), (d), (e), (g), (h) and (i) as above detailed.

4. The fluoroelastomer composition of claim 1, wherein fluoroelastomer (A) has a number-averaged molecular weight of at least 11 000 and/or at most 25 000.

5. The fluoroelastomer composition of claim 1, further comprising at least one of the following:
(a) at least one curing coagent, in amount between 0.5 to 10 phr relative to fluoroelastomer (A);
(b) at least one metallic compound, in amount between 1 and 15 phr relative to fluoroelastomer (A), selected from the group consisting of oxides and hydroxides of divalent metals, optionally combined with a salt of a weak acid;
(c) at least one acid acceptor different from metal oxides.

6. The fluoroelastomer composition according to of claim 1, wherein said composition comprises at least one colorant selected from pigments and dyes, in an amount of 0.1 to 10 phr.

7. A method for fabricating shaped articles, the method comprising shaping a fluoroelastomer composition according to claim 1.

8. A method of fabricating a shaped article, said method comprising:
simultaneously moulding and curing the composition according to claim 1 at a temperature of at most 130° C.,
de moulding the composition so as to obtain a pre-formed article; and
post-curing the pre-formed article in an oven at a temperature of at most 170° C.

9. The method of claim 8, wherein said shaped article is a jewelry item.

10. A Cured article obtained by moulding and curing the fluoroelastomer composition according to claim 1.

11. A method for processing the fluoroelastomer composition according to claim 1, the method comprising liquid injection moulding, screen printing, form-in-place or combinations thereof.

12. The fluoroelastomer composition of claim 3, wherein fluoroelastomer (A) is selected from the group consisting of:
(1) VDF-based copolymers, wherein VDF is copolymerized with at least one comonomer selected from the group consisting of:
(a) tetrafluoroethylene (TFE), hexafluoropropylene (HFP);
(b) vinyl fluoride (VF), trifluoroethylene (TrFE), hexafluoroisobutene (HFIB), perfluoroalkyl ethylenes of formula CH₂═CH—R_{f}, wherein R_{f} is a C₁-C₆ perfluoroalkyl group;
(c) chlorotrifluoroethylene (CTFE);
(d) (per)fluoroalkylvinylethers (PAVE) of formula CF₂═CFOR_{f}, wherein R_{f} is CF₃, C₂F₅, or C₃F₇;
(e) (per)fluoro-oxy-alkylvinylethers of formula CF₂═CFOX, wherein X is perfluoro-2-propoxypropyl;
(f) (per)fluorodioxoles having formula: 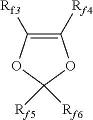
wherein each of R_{f3}, R_{f4}, R_{f5}, R_{f6}, equal to or different from each other, is independently selected from the group consisting of —CF₃, —C₂F₅, —C₃F₇, —OCF₃, and —OCF₂CF₂OCF₃;
(g) (per)fluoro-methoxy-vinylethers having formula:
CF₂═CFOCF₂OR_{f2}
wherein R_{f2} is selected from the group consisting of —CF₂CF₃, —CF₂CF₂OCF₃ and —CF₃;
(h) ethylene and propylene; and
(2) TFE-based copolymers, wherein TFE is copolymerized with at least one comonomer selected from the group consisting of (c), (d), (e), (g) and (h) as above detailed.

13. The fluoroelastomer composition of claim 4, wherein fluoroelastomer (A) has a number-averaged molecular weight of at least 12 000, and/or at most 20 000.

14. The fluoroelastomer composition of claim 5, wherein the curing coagent is selected from the group consisting of triallyl cyanurate; triallyl isocyanurate (TAIC); tris(diallylamine)-s-triazine; triallyl phosphite; N,N diallylacrylamide; N,N,N′,N′-tetraallylmalonamide; trivinyl isocyanurate; 2,4,6-trivinyl methyltri siloxane; and bis-olefins (OF) of formula: 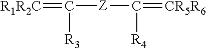
wherein R₁, R₂, R₃, R₄, R₅ and R₆, equal or different from each other, are H or C₁-C₅ alkyl; Z is a linear or branched C₁-C₁₈ hydrocarbon radical, optionally containing oxygen atoms and optionally at least partially fluorinated, or a (per)fluoropolyoxyalkyl ene radical.

15. The fluoroelastomer composition of claim 5, wherein the metallic compound is present in amount between 2 and 10 phr relative to fluoroelastomer (A).

16. The fluoroelastomer composition of claim 5, wherein the metallic compound is selected from the group consisting of oxides and hydroxides of Mg, Zn, Ca or Pb, optionally combined with a salt of a weak acid, for instance Ba, Na, K, Pb, Ca stearates, benzoates, carbonates, oxalates or phosphites.

17. The fluoroelastomer composition of claim 5, wherein the salt of a weak acid is selected from the group consisting of stearates, benzoates, carbonates, oxalates and phosphites of Ba, Na, K, Pb, and Ca.

18. The fluoroelastomer composition of claim 5, wherein the acid acceptor different from metal oxides is 1,8-bis(dimethylamino)naphthalene or octadecylamine.

19. The fluoroelastomer composition of claim 5, wherein:
(a) the curing coagent is selected from the group consisting of triallyl cyanurate; triallyl isocyanurate (TAIC); tris(diallylamine)-s-triazine; triallyl phosphite; N,N diallylacrylamide; N,N,N′,N′-tetraallylmalonamide; trivinyl isocyanurate; 2,4,6-trivinyl methyltrisiloxane; and bis-olefins (OF) of formula: 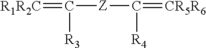
wherein R₁, R₂, R₃, R₄, R₅ and R₆, equal or different from each other, are H or C₁-C₅ alkyl; Z is a linear or branched C₁-C₁₈ hydrocarbon radical, optionally containing oxygen atoms and optionally at least partially fluorinated, or a (per)fluoropolyoxyalkylene radical;
(b) the metallic compound is present in amount between 2 and 10 phr relative to fluoroelastomer (A) and is selected from the group consisting of oxides and hydroxides of Mg, Zn, Ca or Pb, optionally combined with a salt of a weak acid, for instance Ba, Na, K, Pb, Ca stearates, benzoates, carbonates, oxalates or phosphites;
the salt of a weak acid is selected from the group consisting of stearates, benzoates, carbonates, oxalates and phosphites of Ba, Na, K, Pb, and Ca; and
(c) the acid acceptor different from metal oxides is 1,8-bis(dimethylamino)naphthalene or octadecylamine.

20. The method of claim 9, wherein the jewelry item is a bracelet, a wrist bands for a watch, or a packing for outer cladding components of a clock or watch.
